(19) United States
(12) Patent Application Publication
(10) Pub. No.: US 2016/0283259 A1
(43) Pub. Date: Sep. 29, 2016

(54) MANAGEMENT OF AGENTLESS VIRTUAL MACHINES VIA SECURITY VIRTUAL APPLIANCE

(71) Applicant: McAfee, Inc., Santa Clara, CA (US)

(72) Inventor: Kunal Mehta, Hillsboro, OR (US)

(73) Assignee: McAfee, Inc., Santa Clara, CA (US)

(21) Appl. No.: 14/672,167

(22) Filed: Mar. 28, 2015

(51) Int. Cl. G06F 9/455; G06F 9/54

(52) U.S. Cl. CPC G06F 9/45558; G06F 9/54; G06F 2009/4557

(57) ABSTRACT

In an example, a virtual data center includes a plurality of agentless virtual machines (VMs) protected by a security virtual appliance (SVA). Because the VMs are agentless, they cannot internally manage, update, or enforce VM-specific security policies. However, each VM includes an API that provides an interface for monitoring events such as turn on, turn off, heartbeats, and file events, as well as an interface for ordering an on-demand scan. The SVA builds a policy table, with entries for each VM or class of VMs, and using the API, monitors appropriate events, such as file events, to enforce VM-specific policies. Because the policy table is lightweight, it can be efficiently ported between multiple hypervisors, thus ensuring that a VMs policy remains intact, even if that VM is ported to a different hypervisor.

### FIELD OF THE DISCLOSURE

This application relates to the field of computer security, and more particularly to a system and method for management of agentless virtual machines via a security management appliance.

### BACKGROUND

Virtualization has substantially altered the world of computing, particularly on the “back end” or server side. In the past, a number of physical machines would be provided with an appropriate operating system and software packages for providing services, and then physically deployed in a data center. In this situation, if the provisioned hardware was not sufficient to meet demand, additional servers had to be added to the farm. Any excess bandwidth on any of those servers was essentially wasted as overhead. To ensure full hardware utilization, some servers would share two or more functions, such as a single server providing both user authentication services and network file system access.

In a more modern approach, individual server blades may be deployed in a rackmount configuration, where individual blades are treated as fungible and expendable. A hypervisor is launched on this computing cluster, and selecting from a group of functional computing images, the hypervisor launches as virtual machine instances of each function as required. To meet demand, the hypervisor can monitor demand on particular functions, and seamlessly launch extra instances of a function when demand increases, and then kill those instances once demand falls off.

### BRIEF DESCRIPTION OF THE DRAWINGS

The present disclosure is best understood from the following detailed description when read with the accompanying figures. It is emphasized that, in accordance with the standard practice in the industry, various features are not drawn to scale and are used for illustration purposes only. In fact, the dimensions of the various features may be arbitrarily increased or reduced for clarity of discussion.

FIG. 1 is a block diagram of a security-enabled network according to one or more examples of the present Specification.

FIG. 2 is a block diagram of an agentless VM according to one or more examples of the present Specification.

FIG. 3 is a block diagram of a security virtual appliance (SVA) according to one or more examples of the present Specification.

FIG. 4 is a block diagram of a management console according to one or more examples of the present Specification.

FIG. 5 is a block diagram of a virtual computing cluster according to one or more examples of the present Specification.

FIG. 6 is a stack diagram of functional components of a system according to one or more examples of the present Specification.

FIG. 7 is a block diagram of policy aggregation according to one or more examples of the present Specification.

FIG. 8 is a block diagram of a graphical management interface according to one or more examples of the present Specification.

FIG. 9 is a flow chart of a method performed by an SVA according to one or more examples of the present Specification.

FIG. 10 is a flow chart of a method performed by an SVA according to one or more examples of the present Specification.

FIG. 11 is a flow chart of a method performed by a management console according to one or more examples of the present Specification.

### DETAILED DESCRIPTION OF THE EMBODIMENTS

### Overview

In an example, a virtual data center includes a plurality of agentless virtual machines (VMs) protected by a security virtual appliance (SVA). Because the VMs are agentless, they cannot internally manage, update, or enforce VM-specific security policies. However, each VM includes an API that provides an interface for monitoring events such as turn on, turn off, heartbeats, and file events, as well as an interface for ordering an on-demand scan. The SVA builds a policy table, with entries for each VM or class of VMs, and using the API, monitors appropriate events, such as file events, to enforce VM-specific policies. Because the policy table is lightweight, it can be efficiently ported between SVAs running on multiple hypervisors, thus ensuring that a VMs policy remains intact, even if that VM is ported to a different hypervisor.

### Example Embodiments of the Disclosure

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed.

Different embodiments many have different advantages, and no particular advantage is necessarily required of any embodiment.

Despite advantages with respect to hardware utilization and quick reaction times to changing network conditions, the move to virtualization also has presented challenges.

For example, each virtual machine may be provided by a prebuilt VM image, which is configured in advance with the necessary functionality. Thus, while in the past a single physical server may have served multiple functions, in the world of virtualization, it may be advantageous to provide a separate relatively lightweight VM image for each discrete network function. As load changes on one function or the other, virtual machines may be provisioned for killed to meet demand.

Many of the functions performed by VMs may be available via free or open source software, such as a Linux operating systems running open source servers such as Apache, FreeNAS, FileZilla, and many, many others. Advantageously, free and open source software may be provided without per-processor or per-seat licensing restrictions, so that VM instances can be provisioned at will to meet demand. Indeed, some functions are so well defined that is often not desirable or beneficial to create a custom installation of a server image. Rather, many “pre-canned” and preconfigured server images are readily available as “virtual appliances.” These can be managed and configured via configuration files or via web pages served by the appliances themselves, and quickly deployed.

With such preconfigured images, it may not be practical or desirable to install additional software packages on the image. Not only are such custom installations cumbersome, but they can break workflows and interfere with standardized environments. For example, in virtual environments managed by a VMware vCenter system (itself a virtual appliance), VMware discourages users from installing extra software packages onto virtual appliances.

This ecosystem can create challenges from a security standpoint. Because configuration of a server image is limited to software already installed, one or more VMs may be agentless with respect to security. For example, McAfee, Inc. provides many installable security agents for endpoint devices with a broad range of effective and customizable features and configurations. But those features are inaccessible to an agentless VM.

One method of providing security to agentless VMs is to functionally place the VMs behind a firewall, virus scanner, or other similar appliance that monitors and scans all incoming traffic, and rejects malicious traffic.

While this method can be useful in certain deployment scenarios, it lacks the flexibility provided by agentful VMs, which have a security agent installed on each machine. With an agentful VM, security policy can be provided on per-VM bases, referred to as policy per VM (PPVM). PPVM provides much greater security flexibility then a single “gatekeeper” architecture wherein a single policy is applied to all incoming traffic for all endpoints.

The system and method described in the present specification provide a flexible and extensible PPVM framework for managing a plurality of agentless VMs.

In an example of the present specification, each VM is provided with a VM application programming interface (API) driver for interfacing with the virtual environment. The VM API driver is generally already included in a pre-configured virtual appliance, and thus does not require any extra installation.

In an example, the VM API driver provides interfaces for allowing another one VM to subscribe to and receive notification of events on a second VM, such as turn on, turn off, heartbeat, and file read, write, create, and access events. The VM API driver may also provide commands for reading files, reading portions of files, writing to files, deleting files, moving files, reading or writing to the registry or similar configuration space, or ordering a full scan in which each file on the machine is “touched,” thus generating a file access event.

Taking advantage of the VM API, a single security virtual appliance (SVA) may be deployed on a hypervisor, and may be configured to manage security on all agentless VM's within the hypervisor. The SVA may include a policy table, containing at least one entry for each agentless VM. The policy table includes per-VM policies for reacting to defined security events for the VM. Using the VM API, the SVA can monitor, scan, quarantine, inoculate, and remediate file systems, as though it were running on the VM itself.

To provide just one simplified and nonlimiting illustrative example, when a new file appears on a particular VM, the VM API driver may publish a “file write” event to the SVA. To “scan” the file as a security agent would do on an agentful machine, the SVA may request all or a portion of the contents of the file via the API. After receiving contents from the file, the SVA may hash the contents or otherwise compare the content to known virus signature or fingerprints. If no match is found, no further action is taken. On the other hand, if the file is found to be malicious, the SVA may use the API to instruct the VM to delete, quarantine, or otherwise remedy the malicious file. Such a policy can be defined on a per-VM basis (i.e., PPVM). For example, a file containing a virus based on a Microsoft Windows exploit may be considered malicious and dangerous on a Windows-based VM. However, the same file may be benign or useless on a Linux-based VM. Thus, the policy for reacting to a file on a Windows VM may be more involved than the policy for reacting to the same file on a Linux VM. In totality, PPVM allows a security administrator to configure various scan parameters (i.e., scanning policies) for scanning files on different VMs. This can include, for example, vendor specific custom features. For example, when file events come from a VM to an SVA, for some selected VMs, it may be beneficial to configure the scanning engine on the SVA to scan for candidate malicious objects as well. For other VMs, it may be preferable to omit the additional scanning.

McAfee Inc., for example, provides a management console called ePolicyOrchestrator (ePO). ePO includes graphical tools for viewing a network topology of a virtual cluster, selecting individual machines, classes of machines, or groups of machines within the virtual cluster, and specifying a PPVM for each VM in the cluster.

Thus, system administrators accustomed to the useful interface of ePO or other similar security management consoles may be frustrated when encountering agentless VMs, because the agentless VM does not have any software components (for example, a McAfee® agent) from a security vendor. Thus, a security administrator cannot configure it from a security management console, such as ePO, since the VM is “unmanaged” from the management console's standpoint. However, with the framework of the present Specification running with a security management console, SVAs protect individual VMs on each hypervisor under a cluster. Thus, the security administrator can configure and manage individual VMs and classes of VMs within the cluster as seamlessly as if the individual VMs had security agents. Without the teachings of this Specification, those VMs could receive only a single policy per hypervisor.

Further advantageously, the framework of the present Specification is extensible and adaptable, so that it can be molded to the needs of a particular deployment.

A system and method for management of agentless virtual machines via a security virtual appliance will now be described with more particular reference to the appended FIGURES. Throughout the FIGURES, common numerals are used to specify common elements across multiple FIGURES. However, this is not intended to imply a necessary or strict relationship between different embodiments disclosed herein. In some cases, one or more different examples or species of the same elements may be referred to in a hyphenated form. Thus, for example, the numerals 1xx-1 and 1xx-2 may refer to two different species or examples of a class of objects referred to as 1xx.

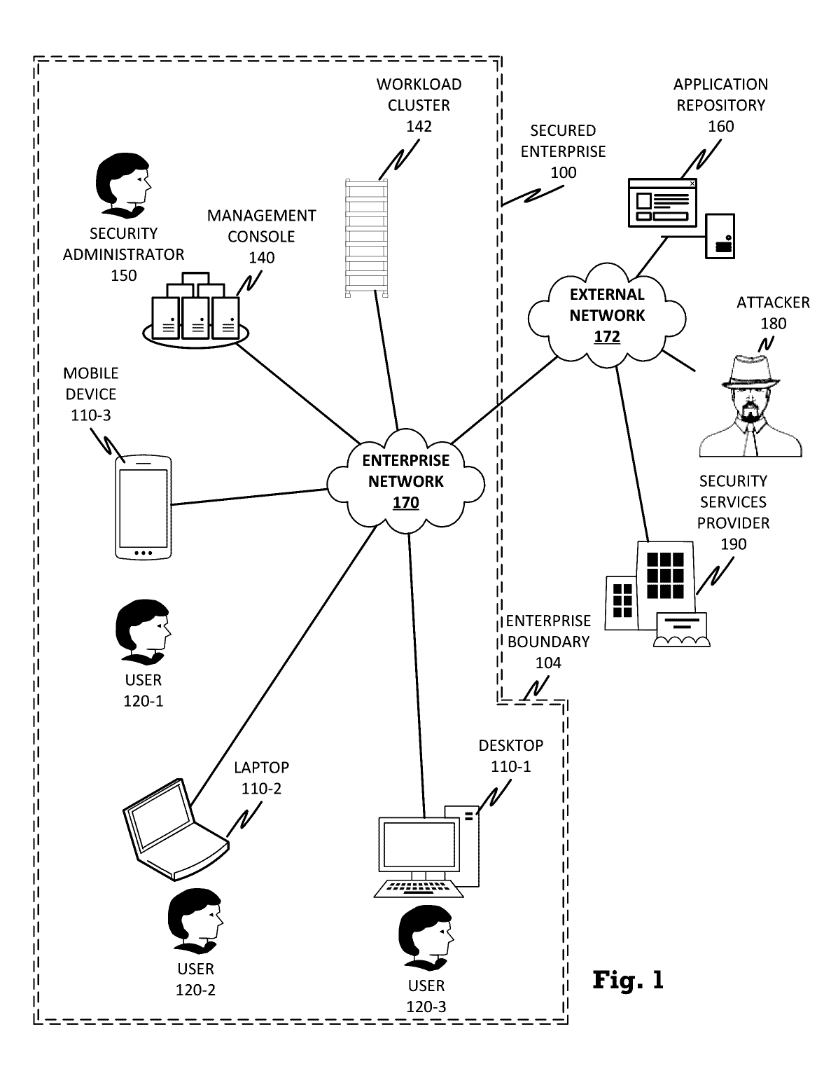

FIG. 1 is a network-level diagram of a secured enterprise 100 according to one or more examples of the present Specification. In the example of FIG. 1, a plurality of users 120 operate a plurality of client devices 110. Specifically, user 120-1 operates desktop computer 110-1. User 120-2 operates laptop computer 110-2. And user 120-3 operates mobile device 110-3.

Each computing device may include an appropriate operating system, such as Microsoft Windows, Linux, Android, Mac OSX, Apple iOS, Unix, or similar. Some of the foregoing may be more often used on one type of device than another. For example, desktop computer 110-1, which in one embodiment may be an engineering workstation, may be more likely to use one of Microsoft Windows, Linux, Unix, or Mac OSX. Laptop computer 110-2, which is usually a portable off-the-shelf device with fewer customization options, may be more likely to run Microsoft Windows or Mac OSX. Mobile device 110-3 may be more likely to run Android or iOS. However, these examples are not intended to be limiting.

Client devices 110 may be communicatively coupled to one another and to other network resources via enterprise network 170. Enterprise network 170 may be any suitable network or combination of one or more networks operating on one or more suitable networking protocols, including for example, a local area network, an intranet, a virtual network, a wide area network, a wireless network, a cellular network, or the Internet (optionally accessed via a proxy, virtual machine, or other similar security mechanism) by way of nonlimiting example. Enterprise network 170 may also include one or more servers, firewalls, routers, switches, security appliances, antivirus servers, or other useful network devices. In this illustration, enterprise network 170 is shown as a single network for simplicity, but in some embodiments, enterprise network 170 may include a large number of networks, such as one or more enterprise intranets connected to the internet. Enterprise network 170 may also provide access to an external network, such as the Internet, via external network 172. External network 172 may similarly be any suitable type of network.

A workload cluster 142 may be provided, for example as a virtual cluster running in a hypervisor on a plurality of rack-mounted blade servers. Workload cluster 142 may provide one or more server functions, or one or more “microclouds” in one or more hypervisors. For example, a virtualization environment such as vCenter may provide the ability to define a plurality of “tenants,” with each tenant being functionally separate from each other tenant, and each tenant operating as a single-purpose microcloud. Each microcloud may serve a distinctive function, and may include a plurality of VMs of many different flavors, including agentful and agentless VMs. It should also be noted that some functionality of endpoint devices 110 may also be provided via workload cluster 142. For example, one microcloud may provide a remote desktop hypervisor such as a Citrix workspace, which allows users 120 operating endpoints 110 to remotely login to a remote enterprise desktop and access enterprise applications, workspaces, and data. In that case, endpoint 110 could even be a “thin client” such as a Google Chromebook, running only a stripped-down operating system, and still provide user 110 useful access to enterprise resources.

One or more computing devices configured as a management console 140 may also operate on enterprise network 170. Management console 140 may provide a user interface for a security administrator 150 to define enterprise security policies, which management console 140 may enforce on enterprise network 170 and across client devices 110 and workload cluster 142.

Secured enterprise 100 may encounter a variety of “security objects” on the network. A security object may be any object that operates on or interacts with enterprise network 170 and that has actual or potential security implications. In one example, object may be broadly divided into hardware objects, including any physical device that communicates with or operates via the network, and software objects. Software objects may be further subdivided as “executable objects” and “static objects.” Executable objects include any object that can actively execute code or operate autonomously, such as applications, drivers, programs, executables, libraries, processes, runtimes, scripts, macros, binaries, interpreters, interpreted language files, configuration files with inline code, embedded code, and firmware instructions by way of non-limiting example. A static object may be broadly designated as any object that is not an executable object or that cannot execute, such as documents, pictures, music files, text files, configuration files without inline code, videos, and drawings by way of non-limiting example. In some cases, hybrid software objects may also be provided, such as for example a word processing document with built-in macros or an animation with inline code. For security purposes, these may be considered as a separate class of software object, or may simply be treated as executable objects.

Enterprise security policies may include authentication policies, network usage policies, network resource quotas, antivirus policies, and restrictions on executable objects on client devices 110 by way of non-limiting example. Various network servers and/or VMs within workload cluster 142 may provide other substantive services such as routing, networking, enterprise data services, and enterprise applications.

Secure enterprise 100 may communicate across enterprise boundary 104 with external network 172. Enterprise boundary 104 may represent a physical, logical, or other boundary. External network 172 may include, for example, websites, servers, network protocols, and other network-based services. In one example, an application repository 160 is available via external network 172, and an attacker 180 (or other similar malicious or negligent actor) also connects to external network 172.

It may be a goal of users 120 and secure enterprise 100 to successfully operate client devices 110 and workload cluster 142 without interference from attacker 180 or from unwanted security objects. In one example, attacker 180 is a malware author whose goal or purpose is to cause malicious harm or mischief. The malicious harm or mischief may take the form of installing root kits or other malware on client devices 110 to tamper with the system, installing spyware or adware to collect personal and commercial data, defacing websites, operating a botnet such as a spam server, or simply to annoy and harass users 120. Thus, one aim of attacker 180 may be to install his malware on one or more client devices 110. As used throughout this Specification, malicious software (“malware”) includes any security object configured to provide unwanted results or do unwanted work. In many cases, malware objects will be executable objects, including by way of non-limiting examples, viruses, trojans, zombies, rootkits, backdoors, worms, spyware, adware, ransomware, dialers, payloads, malicious browser helper objects, tracking cookies, loggers, or similar objects designed to take a potentially-unwanted action, including by way of non-limiting example data destruction, covert data collection, browser hijacking, network proxy or redirection, covert tracking, data logging, keylogging, excessive or deliberate barriers to removal, contact harvesting, and unauthorized self-propagation.

Attacker 180 may also want to commit industrial or other espionage against secured enterprise 100, such as stealing classified or proprietary data, stealing identities, or gaining unauthorized access to enterprise resources. Thus, attacker 180's strategy may also include trying to gain physical access to one or more client devices 110 and operating them without authorization, so that an effective security policy may also include provisions for preventing such access.

In another example, a software developer may not explicitly have malicious intent, but may develop software that poses a security risk. For example, a well-known and often-exploited security flaw is the so-called buffer overrun, in which a malicious user is able to enter an overlong string into an input form and thus gain the ability to execute arbitrary instructions or operate with elevated privileges on a computing device 110 or on a VM within workload cluster 142. Buffer overruns may be the result, for example, of poor input validation or use of insecure libraries, and in many cases arise in nonobvious contexts. Thus, although not malicious himself, a developer contributing software to application repository 160 may inadvertently provide attack vectors for attacker 180. Poorly-written applications may also cause inherent problems, such as crashes, data loss, or other undesirable behavior. Because such software may be desirable itself, it may be beneficial for developers to occasionally provide updates or patches that repair vulnerabilities as they become known. However, from a security perspective, these updates and patches are essentially new

Application repository 160 may represent a Windows or Apple “app store” or update service, a Unix-like repository or ports collection, or other network service providing users 120 the ability to interactively or automatically download and install applications on client devices 110. If application repository 160 has security measures in place that make it difficult for attacker 180 to distribute overtly malicious software, attacker 180 may instead stealthily insert vulnerabilities into apparently-beneficial applications.

In some cases, secured enterprise 100 may provide policy directives that restrict the types of applications that can be installed from application repository 160. Thus, application repository 160 may include software that is not negligently developed and is not malware, but that is nevertheless against policy. For example, some enterprises restrict installation of entertainment software like media players and games. Thus, even a secure media player or game may be unsuitable for an enterprise computer. Security administrator 150 may be responsible for distributing a computing policy consistent with such restrictions and enforcing it on client devices 110 and on workload cluster 142 as appropriate.

Secured enterprise 100 may also contract with or subscribe to a security services provider 190, which may provide security services, updates, antivirus definitions, patches, products, and services. McAfee®, Inc. is a non-limiting example of such a security services provider that offers comprehensive security and antivirus solutions. In some cases, security services provider 190 may include a threat intelligence capability such as the global threat intelligence (GTI™) database provided by McAfee Inc. Security services provider 190 may update its threat intelligence database by analyzing new candidate malicious objects as they appear on client networks and characterizing them as malicious or benign.

In another example, secured enterprise 100 may simply be a family, with parents assuming the role of security administrator 150. The parents may wish to protect their children from undesirable content, such as pornography, adware, spyware, age-inappropriate content, advocacy for certain political, religious, or social movements, or forums for discussing illegal or dangerous activities, by way of non-limiting example. In this case, the parent may perform some or all of the duties of security administrator 150.

Collectively, any object that is or can be designated as belonging to any of the foregoing classes of undesirable objects may be classified as a malicious object. When an unknown object is encountered within secured enterprise 100, it may be initially classified as a “candidate malicious object.” This designation may be to ensure that it is not granted full network privileges until the object is further analyzed. Thus, it is a goal of users 120 and security administrator 150 to configure and operate client devices 110 and workload cluster 142 so as to exclude all malicious objects, and to promptly and accurately classify candidate malicious objects.

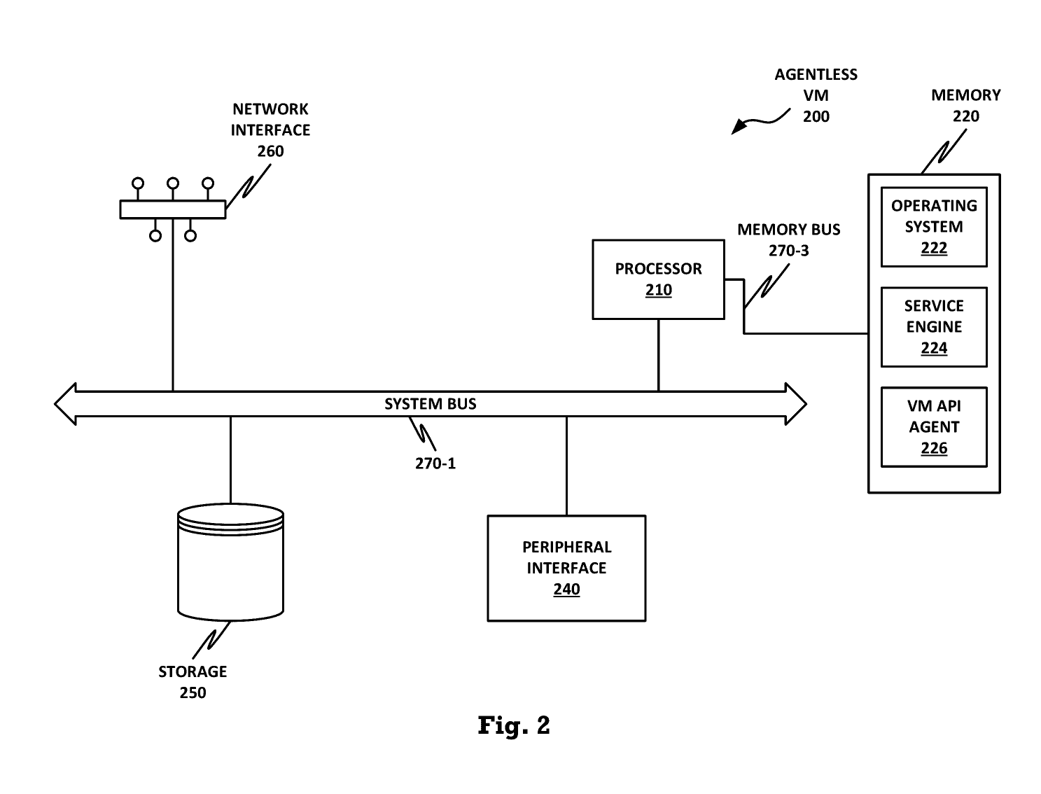

FIG. 2 is a block diagram of an agentless VM 200 according to one or more examples of the present Specification. Agentless VM 200 may be any suitable computing device. In various embodiments, a “computing device” may be or comprise, by way of non-limiting example, a computer, workstation, server, mainframe, embedded computer, embedded controller, embedded sensor, personal digital assistant, laptop computer, cellular telephone, IP telephone, smart phone, tablet computer, convertible tablet computer, computing appliance, network appliance, receiver, wearable computer, handheld calculator, or any other electronic, microelectronic, or microelectromechanical device for processing and communicating data.

Agentless VM 200 includes a processor 210 connected to a memory 220, having stored therein executable instructions for providing an operating system 222 and at least software portions of a service engine 224. Other components of agentless VM 200 include a storage 250, network interface 260, and peripheral interface 240. This architecture is provided by way of example only, and is intended to be non-exclusive and non-limiting. Furthermore, the various parts disclosed are intended to be logical divisions only, and need not necessarily represent physically separate hardware and/or software components, particularly with respect to virtual machines. Certain computing devices provide main memory 220 and storage 250, for example, in a single physical memory device, and in other cases, memory 220 and/or storage 250 are functionally distributed across many physical devices. In many virtualized environments, storage 250 may be provided as a persistent memory space for the VM, while heavier data operations may be offloaded to a database server, which could be in an entirely different cluster or microcloud.

In the case of virtual machines or hypervisors, all or part of a function may be provided in the form of software or firmware running over a virtualization layer to provide the disclosed logical function. In other examples, a device such as a network interface 260 may provide only the minimum hardware interfaces necessary to perform its logical operation, and may rely on a software driver to provide additional necessary logic. Thus, each logical block disclosed herein is broadly intended to include one or more logic elements configured and operable for providing the disclosed logical operation of that block. As used throughout this Specification, “logic elements” may include hardware, external hardware (digital, analog, or mixed-signal), software, reciprocating software, services, drivers, interfaces, components, modules, algorithms, sensors, components, firmware, microcode, programmable logic, or objects that can coordinate to achieve a logical operation.

In an example, processor 210 is communicatively coupled to memory 220 via memory bus 270-3, which may be for example a direct memory access (DMA) bus by way of example, though other memory architectures are possible, including ones in which memory 220 communicates with processor 210 via system bus 270-1 or some other bus. Processor 210 may be communicatively coupled to other devices via a system bus 270-1. As used throughout this Specification, a “bus” includes any wired or wireless interconnection line, network, connection, bundle, single bus, multiple buses, crossbar network, single-stage network, multistage network, virtual bus, or other conduction medium operable to carry data, signals, or power between parts of a computing device, or between computing devices. It should be noted that these uses are disclosed by way of non-limiting example only, and that some embodiments may omit one or more of the foregoing buses, while others may employ additional or different buses.

In various examples, a “processor” may include any combination of logic elements, including by way of non-limiting example a microprocessor, digital signal processor, field-programmable gate array, graphics processing unit, programmable logic array, application-specific integrated circuit, or virtual machine processor. In certain architectures, a multi-core processor may be provided, in which case processor 210 may be treated as only one core of a multi-core processor, or may be treated as the entire multi-core processor, as appropriate. In some embodiments, one or more co-processor may also be provided for specialized or support functions.

Processor 210 may be connected to memory 220 in a DMA configuration via DMA bus 270-3. To simplify this disclosure, memory 220 is disclosed as a single logical block, but in a physical embodiment may include one or more blocks of any suitable volatile or non-volatile memory technology or technologies, including for example DDR RAM, SRAM, DRAM, cache, L1 or L2 memory, on-chip memory, registers, flash, ROM, optical media, virtual memory regions, magnetic or tape memory, or similar. In certain embodiments, memory 220 may comprise a relatively low-latency volatile main memory, while storage 250 may comprise a relatively higher-latency non-volatile memory. However, memory 220 and storage 250 need not be physically separate devices, and in some examples may represent simply a logical separation of function. It should also be noted that although DMA is disclosed by way of non-limiting example, DMA is not the only protocol consistent with this Specification, and that other memory architectures are available.

Storage 250 may be any species of memory 220, or may be a separate device. Storage 250 may include one or more non-transitory computer-readable mediums, including by way of non-limiting example, a hard drive, solid-state drive, external storage, redundant array of independent disks (RAID), network-attached storage, optical storage, tape drive, backup system, cloud storage, or any combination of the foregoing. Storage 250 may be, or may include therein, a database or databases or data stored in other configurations, and may include a stored copy of operational software such as operating system 222 and software portions of service engine 224 and VM API agent 226. Many other configurations are also possible, and are intended to be encompassed within the broad scope of this Specification.

Network interface 260 may be provided to communicatively couple agentless VM 200 to a wired or wireless network. A “network,” as used throughout this Specification, may include any communicative platform operable to exchange data or information within or between computing devices, including by way of non-limiting example, an ad-hoc local network, an Internet architecture providing computing devices with the ability to electronically interact, a plain old telephone system (POTS), which computing devices could use to perform transactions in which they may be assisted by human operators or in which they may manually key data into a telephone or other suitable electronic equipment, any packet data network (PDN) offering a communications interface or exchange between any two nodes in a system, or any local area network (LAN), metropolitan area network (MAN), wide area network (WAN), wireless local area network (WLAN), virtual private network (VPN), intranet, or any other appropriate architecture or system that facilitates communications in a network or telephonic environment.

Service engine 224, in one example, is operable to carry out computer-implemented methods as described in this Specification. Service engine 224 may include one or more non-transitory computer-readable mediums having stored thereon executable instructions operable to instruct a processor to provide a security engine. As used throughout this Specification, an “engine” includes any combination of one or more logic elements, of similar or dissimilar species, operable for and configured to perform one or more methods provided by service engine 224. Thus, service engine 224 may comprise one or more logic elements configured to provide methods as disclosed in this Specification. In some cases, service engine 224 may include a special integrated circuit designed to carry out a method or a part thereof, and may also include software instructions operable to instruct a processor to perform the method. In some cases, service engine 224 may run as a “daemon” process. A “daemon” may include any program or series of executable instructions, whether implemented in hardware, software, firmware, or any combination thereof, that runs as a background process, a terminate-and-stay-resident program, a service, system extension, control panel, bootup procedure, BIOS subroutine, or any similar program that operates without direct user interaction. In certain embodiments, daemon processes may run with elevated privileges in a “driver space,” or in ring 0, 1, or 2 in a protection ring architecture. It should also be noted that service engine 224 may also include other hardware and software, including configuration files, registry entries, and interactive or user-mode software by way of non-limiting example.

In one example, service engine 224 includes executable instructions stored on a non-transitory medium operable to perform a method according to this Specification. At an appropriate time, such as upon booting agentless VM 200 or upon a command from operating system 222 or a user 120, processor 210 may retrieve a copy of service engine 224 (or software portions thereof) from storage 250 and load it into memory 220. Processor 210 may then iteratively execute the instructions of service engine 224 to provide the desired method.

Functionally, service engine 224 provides the substantive “service” of agentless VM 200. For example, if agentless VM 224 is a file server, service engine 224 may include FreeNAS, as well as an OpenZFS file system driver running on FreeBSD. For other functions, other components of service engine 224 may be provided.

VM API agent 226 is also an engine as described above. Service engine 224 and VM API agent 226 may both be pre-installed on a virtual appliance image. VM API agent 226 provides the VM API as described herein. The VM API agent may enable another VM to subscribe to events on agentless VM 200. These may include, by way of nonlimiting example, turn on (when the VM “spins up” or is otherwise provisioned and becomes available), turn off (when the VM crashes or is terminated), heartbeat (sent periodically to indicate that the VM is still “alive”), and file read, write, create, or access events (notification sent when any of those actions occur). VM API 226 may also provide interactive APIs, by which an external VM with appropriate permissions can manipulate the internal file system of agentless VM 200. For example, VM API 226 may expose features such as on-demand scan (in which some or all of the files on agentless VM 200 are “touched,” thus generating a file access event for each that can be intercepted by the other VM), file reads (in which agentless VM 200 returns all or part of a requested file to another VM), file write (in which agentless VM 200 receives a file to be written or overwritten on its internal file system), and read-from or write-to registry on Microsoft Windows VM (enabling the other VM to read and manipulate registry keys).

Where appropriate, peripheral interface 240 may also be provided, and may be configured to interface with any auxiliary device that connects to agentless VM 200 but that is not necessarily a part of the core architecture of agentless VM 200. A peripheral may be operable to provide extended functionality to agentless VM 200, and may or may not be wholly dependent on agentless VM 200. In some cases, a peripheral may be a computing device in its own right. Peripherals may include input and output devices such as displays, terminals, printers, keyboards, mice, modems, network controllers, sensors, transducers, actuators, controllers, data acquisition buses, cameras, microphones, speakers, or external storage by way of non-limiting example. In some cases, peripheral interface 240 may include a lightweight web server serving a web page that exposes configuration options and functions, accessible via a network.

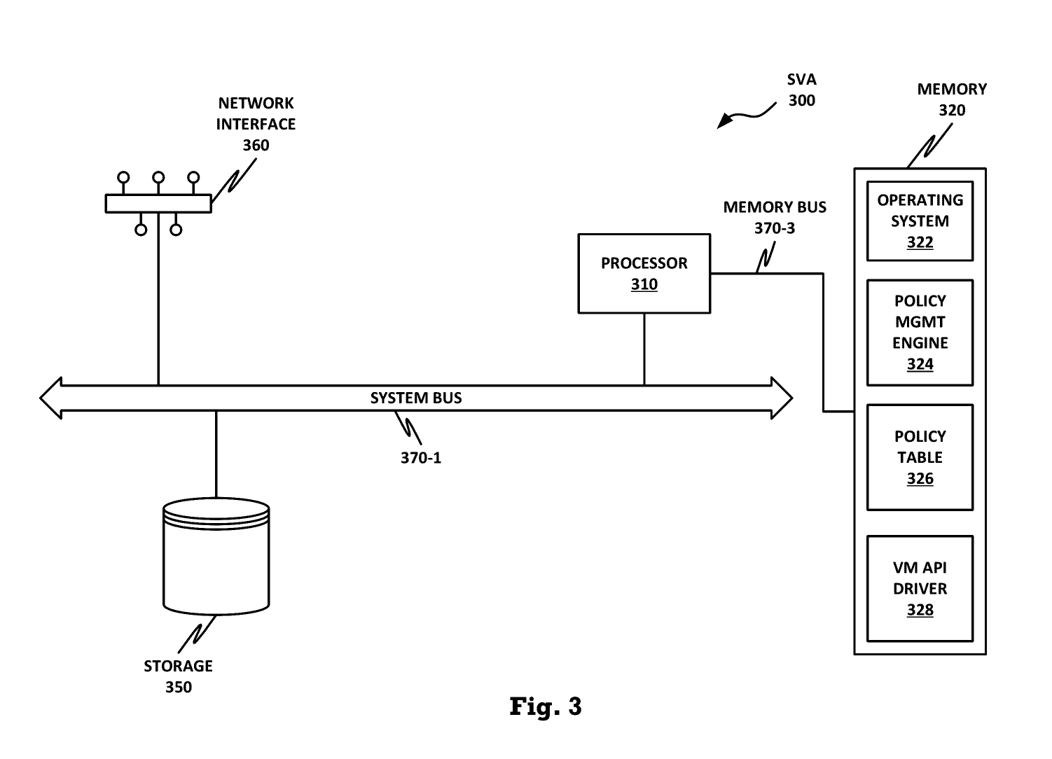

FIG. 3 is a block diagram of a security virtual appliance (SVA) 300 according to one or more examples of the present Specification. SVA 300 may be any suitable computing device, as described in connection with FIG. 2. In general, the definitions and examples of FIG. 2 may be considered as equally applicable to FIG. 3, unless specifically stated otherwise. SVA 300 is described herein separately to illustrate that in certain embodiments, logical operations according to this Specification may be divided along a client-server model, wherein agentless VM 200 provides certain localized tasks, while SVA 300 provides certain other centralized tasks.

SVA 300 includes a processor 310 connected to a memory 320, having stored therein executable instructions for providing an operating system 322 and at least software portions of a policy management engine 324, policy table 326, and VM API driver 328. Other components of SVA 300 include a storage 350, network interface 360, and peripheral interface 340. As described in FIG. 2, each logical block may be provided by one or more similar or dissimilar logic elements.

In an example, processor 310 is communicatively coupled to memory 320 via memory bus 370-3, which may be for example a direct memory access (DMA) bus. Processor 310 may be communicatively coupled to other devices via a system bus 370-1.

Processor 310 may be connected to memory 320 in a DMA configuration via DMA bus 370-3, or via any other suitable memory configuration. As discussed in FIG. 2, memory 320 may include one or more logic elements of any suitable type.

Storage 350 may be any species of memory 320, or may be a separate device, as described in connection with storage 250 of FIG. 2. Storage 350 may be, or may include therein, a database or databases or data stored in other configurations, and may include a stored copy of operational software such as operating system 322 and software portions of policy management engine 324.

Network interface 360 may be provided to communicatively couple SVA 300 to a wired or wireless network, and may include one or more logic elements as described in FIG. 2.

Policy management engine 324 is an engine as described in FIG. 2 and, in one example, includes one or more logic elements operable to carry out computer-implemented methods as described in this Specification. Software portions of policy management engine 324 may run as a daemon process.

Policy management engine 324 may include one or more non-transitory computer-readable mediums having stored thereon executable instructions operable to instruct a processor to provide a security engine. At an appropriate time, such as upon booting SVA 300 or upon a command from operating system 222 or a user 120 or security administrator 150, processor 310 may retrieve a copy of policy management engine 324 (or software portions thereof) from storage 350 and load it into memory 320. Processor 310 may then iteratively execute the instructions of policy management engine 324 to provide the desired method.

VM API driver 328 provides an interface to the VM API, allowing SVA 300 to receive notifications of events from agentless VMs 200. Any event notification that has security implications or that is otherwise of interest to policy management engine 324 may be deemed a “security event,” and it may be a design and purpose of policy management engine 324 to take an appropriate action at least in part responsive to the security event.

In an example, policy management engine 324 provides logic for driving a PPVM on a plurality of agentless VMs 200. Policy table 326 may include a matrix including a name and/or UUID for each agentless VM 200, and one or more policy directives. The policy matrix may also include scanning parameters, such as how and when to scan a file on the occurrence of a security event. A policy directive may include, for example, one or more security events, and an associated action to take in response to the security event. After detecting an appropriate event and looking it up on policy table 326, policy management engine 324 may issue instructions via VM API driver 328 to effect the policy.

Peripheral interface 340 may be configured to interface with any auxiliary device that connects to SVA 300 but that is not necessarily a part of the core architecture of SVA 300. A peripheral may be operable to provide extended functionality to SVA 300, and may or may not be wholly dependent on SVA 300. Peripherals may include, by way of non-limiting examples, any of the peripherals disclosed in FIG. 2.

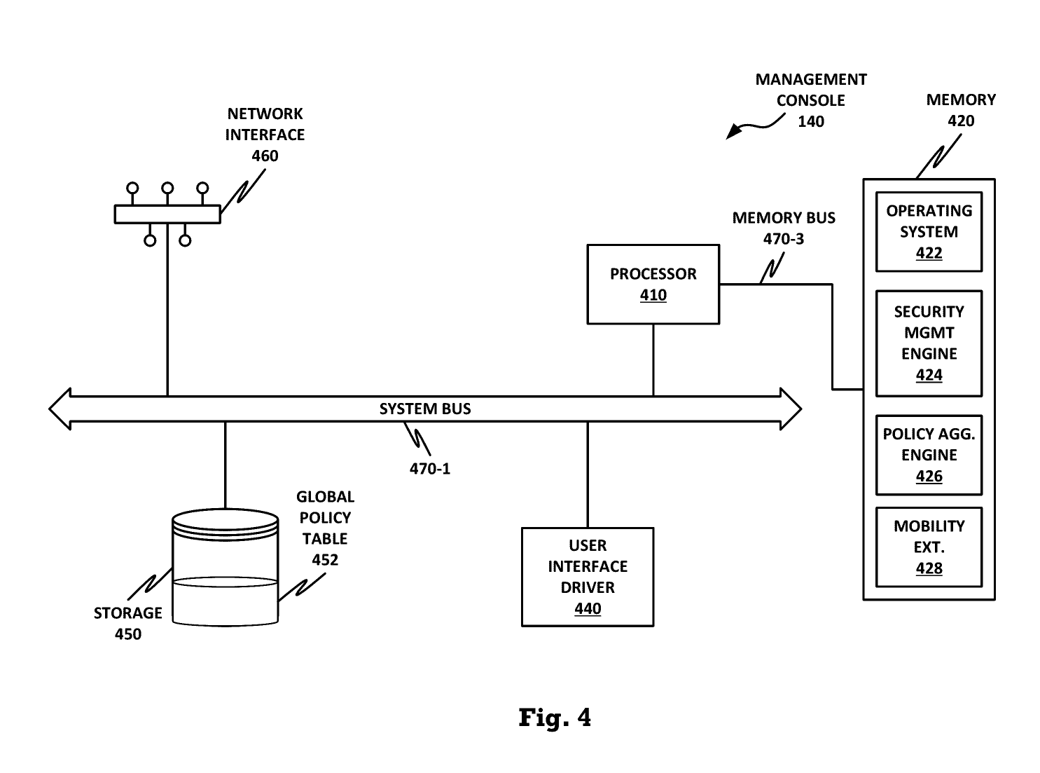

FIG. 4 is a block diagram of a management console 140 according to one or more examples of the present Specification. Management console 400 may be any suitable computing device, as described in connection with FIG. 2. In general, the definitions and examples of FIG. 2 may be considered as equally applicable to FIG. 4, unless specifically stated otherwise. Management console 400 is described herein separately to illustrate that in certain embodiments, logical operations according to this Specification may be divided along a client-server model, wherein agentless VM 200 provides certain localized tasks, while management console 400 provides certain other centralized tasks.

Management console 400 includes a processor 410 connected to a memory 420, having stored therein executable instructions for providing an operating system 422 and at least software portions of a policy management engine 424, policy aggregation engine 426, and mobility extensions 428. Other components of management console 400 include a storage 450, network interface 460, and peripheral interface 440. As described in FIG. 2, each logical block may be provided by one or more similar or dissimilar logic elements.

In an example, processor 410 is communicatively coupled to memory 420 via memory bus 470-3, which may be for example a direct memory access (DMA) bus. Processor 410 may be communicatively coupled to other devices via a system bus 470-1.

Processor 410 may be connected to memory 420 in a DMA configuration via DMA bus 470-3, or via any other suitable memory configuration. As discussed in FIG. 2, memory 420 may include one or more logic elements of any suitable type.

Storage 450 may be any species of memory 420, or may be a separate device, as described in connection with storage 250 of FIG. 2. Storage 450 may be, or may include therein, a database or databases or data stored in other configurations, and may include a stored copy of operational software such as operating system 422 and security management engine 424, policy aggregation engine 426, and mobility extensions 428. Storage 450 may also store and maintain a global policy table, including policies for all currently-provisioned agentless VMs 200.

Network interface 460 may be provided to communicatively couple management console 400 to a wired or wireless network, and may include one or more logic elements as described in FIG. 2.

Security management engine 424 is an engine as described in FIG. 2 and, in one example, includes one or more logic elements operable to carry out computer-implemented methods as described in this Specification. Software portions of security management engine 424 may run as a daemon process.

Security management engine 424 may include one or more non-transitory computer-readable mediums having stored thereon executable instructions operable to instruct a processor to provide a security engine. At an appropriate time, such as upon booting management console 400 or upon a command from operating system 222 or a user 120 or security administrator 150, processor 410 may retrieve a copy of policy management engine 424 (or software portions thereof) from storage 450 and load it into memory 420. Processor 410 may then iteratively execute the instructions of policy management engine 424 to provide the desired method.

Policy aggregation engine 426 receives user inputs, such as from security administrator 150, and generates instructions for providing a security PPVM to one or more agentless VMs 200. Policy aggregation engine 426 then consolidates the policies of a plurality of agentless VMs 200 into an aggregate, such as a text file or single binary blob, for export to SVA 300.

Mobility extensions 428 provides features such as a user interface for managing VM security policies. This may include, for example, configuring scan parameters and other settings normally associated with a scanning engine or antivirus engine.

User interface driver 440 may be provided to present a user interface, such as a graphical user interface, command line textual user interface, or configuration files, to a user such as security administrator 150. User interface driver 440 enables security administrator 1560 to configure security management engine 440, and thereby to manage SVA 300, thus providing PPVM security on agentless VMs 200.

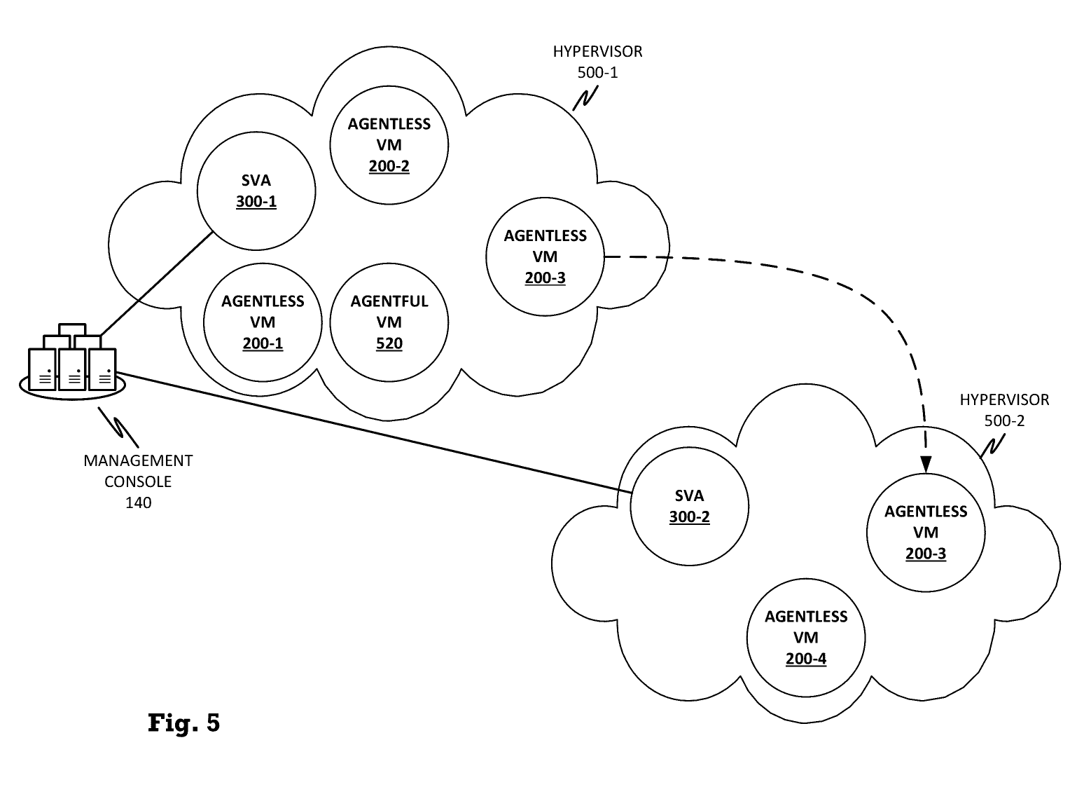

FIG. 5 is a block diagram of a virtual server cluster according to one or more examples of the present specification. In the example of FIG. 5, hypervisors 500-1 and 500-2 are deployed, for example on workload cluster 142 of FIG. 1. Hypervisors 500-1 and 500-2 may both be part of a common microcloud or tenant, or may be or be part of two different microclouds or tenants.

As seen in this figure, hypervisor 500-1 includes SVA 300-1, which is configured to provide PPVM services as described herein. Specifically, hypervisor 500-1 includes agentful VM 520, which does not require the PPVM services of SVA 300-1. Rather, security administrator 150 can configure and manage agentful VM 520 directly via management console 140, which has a direct compatibility layer with agentful VM 520.

However, hypervisor 500-1 also includes a plurality of agentless VMs 200-1, 200-2, and 200-3. Agentless VMs 200 do not include a compatibility layer through which management console 140 can directly manage them. Thus, to provide PPVM service to agentless VMs 200, SVA 300-1 includes a policy management engine 324 of FIG. 3.

in this example, the virtualization manager may support certain load balancing features, such as the VMware vMotion feature, which supports moving a VM from a first hypervisor to a second hypervisor without a complete shutdown/reboot sequence. In that case, certain advantages can be realized. For example, it may be that hypervisor 500-1 is excessively burdened because many instances of a particular flavor of VM are running on it. Thus, it may be desirable to move one or more VMs, such as agentless VM 200-3, to another hypervisor, such as a hypervisor 500-2. In this example, hypervisor 500-2 has only SVA 300-2 and agentless VM 200-4 running on it. Thus, hypervisor 500-2 may have greater available bandwidth than hypervisor 500-1. VMotion can move agentless VM 200-3 from hypervisor 500-1 to hypervisor 500-2. In some cases, hypervisor 500-2 may be an existing hypervisor already provisioned within the cluster. In other examples, hypervisor 500-2 may be specially provision to handle excessive load from hypervisor 500-1.

When agentless VM 200-3 is moved from hypervisor 500-1 to hypervisor 500-2, in order to preserve the PPVM architecture, policies for agentless VM 200-3 must be provided to SVA 300-2. This ensures a seamless transition and preservation of PPVM.

In some cases, when agentless VM 200-3 moves to hypervisor 500-2, management console 140 may receive explicit notification, and may explicitly notify SVA 300-1 of the change. However, this is not necessary in all cases. For example, SVA 300-1 may be provisioned to monitor “heartbeat” signals from agentless VMs 200 via the VM API. In that case, after agentless VM 200-3 is terminated on hypervisor 500-1, SVA 300-1 will be aware of the change. In other examples, agentless VM 200-3 may send a “turn off” API signal to SVA 300-1, in which case once again, SVA 300-1 will be aware of the change.

When SVA 300-1 learns that agentless VM 200-3 has been terminated from hypervisor 500-1, it may be advantageous for SVA 300-1 to remove the superfluous entry from its policy table 326. But it is not desirable to lose the policy entry for agentless VM 200-3. SVA 300-2 still needs the policy entry so that it can continue to manage agentless VM 200-3. Thus, it is desirable to port the policy entry from the policy table of SVA 300-1 to the policy table of SVA 300-2.

This can be accomplished in one of several ways. In a first example, management console 140 maintain a global policy table. This global policy table can be distributed to all SVAs 300. In that case, when an SVA 300 becomes aware of a new agentless VM 200, the SVA 300 makes a new entry in its policy table 326, which can be either blank, or which can inherit a default policy from a parent classification. After creating a new policy entry, SVA 300 notifies management console 140. Management cause 140 may then add the new entry to a global policy table.

The use of a global policy table is feasible because the policy table can be a simple text file, such as XML, JSON, or similar. Compared to other network objects, text files are generally relatively small and portable. Management console 140 can then update the global policy table and distribute it to all SVAs 300. As soon as agentless VM 200-3 moves from hypervisor 500-1 to hypervisor 500-2, hypervisor 500-2 has a current policy table with a valid entry for agentless VM 200-3. In this case,

However, it is still necessary to provide for removal of superfluous policy entries. Otherwise, policy table 326 will become overpopulated with outdated policy entries. Thus, in one example, if SVA 300-1 receives a turn off signal, or loses a heartbeat on agentless VM 200-3, or otherwise becomes aware that agentless VM 200-3 has either crashed or been terminated on hypervisor 500-1, agentless VM 200-3 may notify management console 140 of the change. Because management console 140 has a global view of the cluster, it knows whether agentless VM 200-3 has actually terminated, or whether it has simply been moved to a different hypervisor 500. Thus, management console 140 knows whether to delete the policy entry for agentless VM 200-3, or whether to maintain the policy entry for use by a different SVA 300.

As an additional safeguard, management console 140 may occasionally poll all SVAs 300 in the cluster for a list of all current agentless VM's being managed. Management console 140 may then compare the poll results to its current policy table 326, and remove any superfluous entries. Furthermore, upon initial startup, management console 140 may poll all SVAs 300 and the current cluster for a list of agentless VM's 200 requiring PPVM services. Management console 140 may also have a periodic counter, such as a “cron” job, so that new and updated policies are published to SVAs 300 on a regular schedule. In one example, this occurs by default every sixty minutes, although the timing may be configurable, and security administrator 150 may also perform “on-demand” updates, for example if he has applied a critical policy update that should be published to SVAs 300 immediately.

In another embodiment, a master policy table 326 need not be maintained. Rather, each SVA 300 may maintain a table of only those agentless VM's 200 that it is actively managing. In that case, when SVA 300-1 becomes aware that agentless VM 200-3 has terminated on hypervisor 500-1, SVA 300-1 may upload its current policy entry for agentless VM 200-32 management console 140, and then delete its policy entry for agentless VM 200-3.

Because management console 140 has a globalized view of the cluster, it knows whether agentless VM 200-3 has moved to hypervisor 500-2. Thus, management console 140 knows whether to retain the policy entry, or whether to discard it.

As an additional safeguard, before discarding the policy entry, management console 140 may poll SVAs 300 to determine whether any SVA 300 reports that agentless VM 200-3 is attached in any hypervisor 500. If an SVA 300 reports that agentless VM 200-3 is attached, management console 140 may send a policy entry to that SVA 300. On the other hand, if no SVA 300 reports that agentless VM 200-3 is attached, management console 140 may discard the policy entry for agentless VM 200-3.

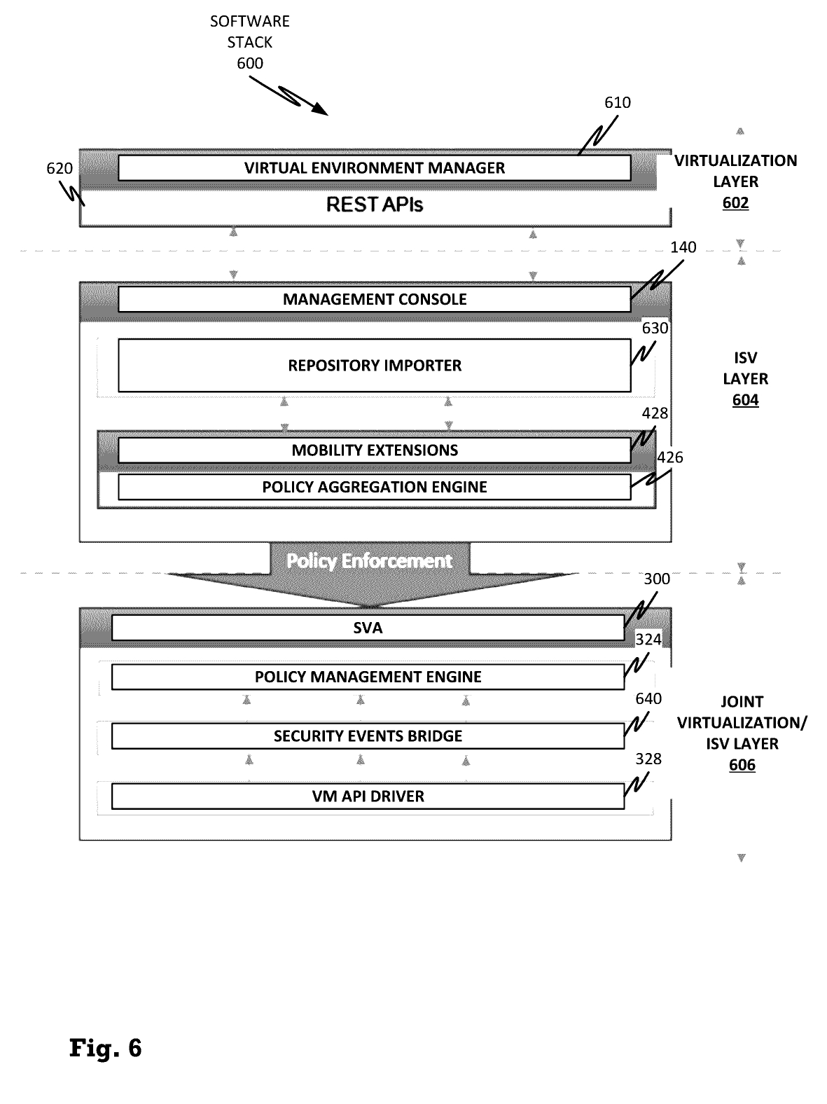

FIG. 6 is a block diagram of an example software stack 600 according to one or more examples of the present specification. In this example, the stack is divided into layers. At the top is the virtualization layer 602, which includes software provided by the vendor of the virtualization technology (for example, VMWare, which provides vCenter). Next, is an ISV layer 604, including software provided by a security ISV such as security services provider 190 of FIG. 1 (for example, McAfee®). Finally, there is a joint virtualization/ISV layer 606, where ISV software interacts with virtualization software, such as via an API.

Within virtualization layer 602 is virtual environment manager 610. This may be a virtualization manager such as VMware vCenter, or similar. Virtual environment manager 610 is responsible for provisioning, managing, terminating, and otherwise handling virtual machines, including agentful VMs 520, and agentless VMs 200.

Management console 140 resides in ISV layer 604. Management console 140 may include mobility extensions 428 and policy aggregation engine 426, as discussed previously. Management console 140 may also include a repository importer 630, which is an engine for finding and structuring the topology of one or more virtual computing clusters.

Management console 140 provides policy enforcement to joint virtualization/ISV layer 606. This layer include software provided by both the virtualization vendor and the ISV. In joint layer 606, SVA 300 provides a security events bridge 640 configured to detect security events and provide those events to policy management engine 324 of FIG. 3. Policy management engine 324 may then use VM API driver 328 to effect the policy on agentless VMs 200.

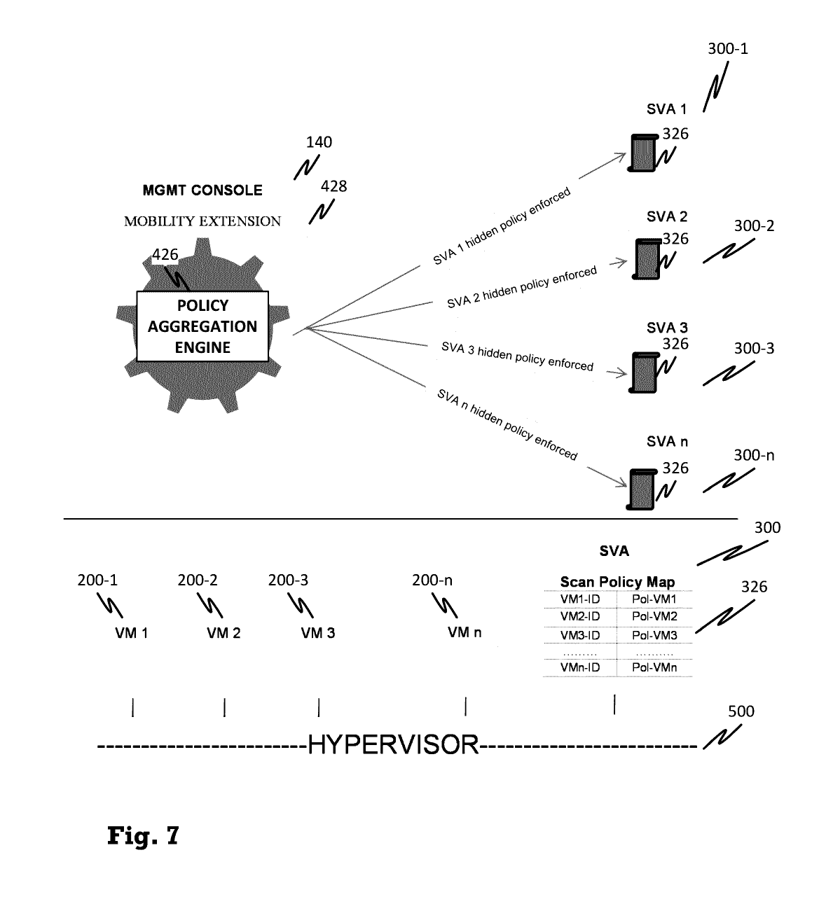

FIG. 7 is a block diagram of policy distribution according to one or more examples of the present specification.

In the example of FIG. 7, management console 140 includes mobility extensions 428 and policy aggregation engine 426. As described in more detail in FIG. 5, policy aggregation engine 426 receives new and updated policy entries from both SVAs 300 and security administrator 150. More generically, policy aggregation engine 426 and mobility extensions 428 may be thought of as extensions to the framework of the teachings of the present Specification. Specifically, they provide the ability to provide a global policy table, and the ability to provide VM mobility between hypervisors.

At appropriate times, such as on periodic intervals, or on demand from security administrator 150, policy aggregation engine 426 distributes the policy table to SVAs 300, either as a global policy table, or as “patches” to existing global or distributed policy table.

SVAs 300 receive and enforce “hidden” policy directives, as described in more detail below.

As illustrated, each SVA 300 includes a policy table 326, which by way of illustration is a global policy table.

This is illustrated in additional detail in the lower part of the figure, in which a hypervisor 500 has connected to it a plurality of agentless VMs 200. SVA 300 has a policy table 326, including identifiers such as UUIDs of agentless VM's 200, and at least one associated policy for each agentless VM 300. The policy in this case may not be a full description of the policy, but rather a cross reference to another table or file with an indexed list of policies. This can save in replication. For example, if two agentless VMs 200 are to receive policy “POL-7,” it is not necessary to include the full body of the policy. Rather, the identifier “POL-7” will direct SVA 300 to the correct entry in a policies table.

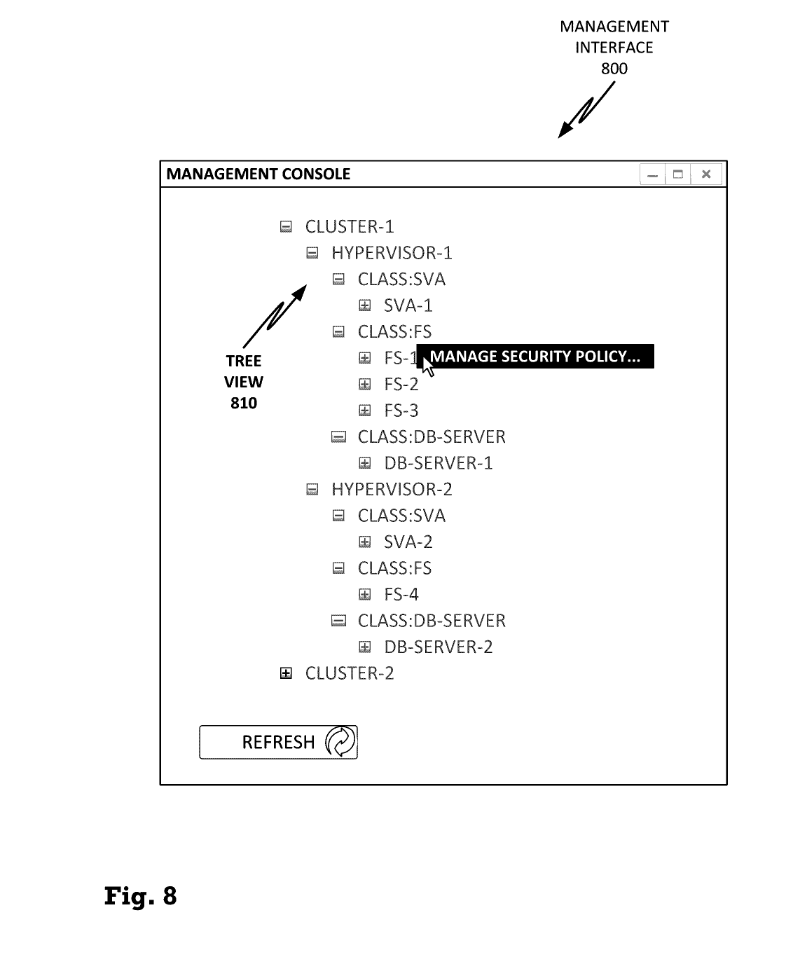

FIG. 8 is a block diagram illustration of an example management graphical user interface, which may be provided, for example, by user interface driver 440 of FIG. 4. In this example, agentless VMs 200 are displayed in a hierarchical fashion by a tree view 810. This tree view includes two clusters, namely CLUSTER-1 and CLUSTER-2. In this example, CLUSTER-1 is expanded so that subordinate elements can be viewed and manipulated

Further in this view, HYPERVISOR-1 and HYPERVISOR-2 are expanded so that subordinate elements can be viewed and manipulated. In this example, VMs are organized by class, namely classes SVA for SVAs 300, class FS for VMs 200 of the fileserver class, and class DB-SERVER for VMs 200 of the database server class.

HYPERVISOR-1 includes a plurality of virtual machines, namely SVA-1 and four agentless VMs 200, namely FS-1, FS-2, FS-3, and DB-SERVER0-1.

HYPERVISOR-2 includes SVA-2 as well as two agentless VMs 300, namely FS-4 and DB-SERVER-2.

CLUSTER-2 is collapsed, so that its subordinate elements are not visible.

This illustrates only one example of a method of displaying and managing virtual clusters. in this example, security administrator 150 may click on the entry for file server FS-1, and may then graphically administer a security policy for that VM. Other management interfaces may also be used, such as textual user interfaces, command lines, and configuration files.

The division of VMs into classes can also be beneficial. For example, it may be desirable not to administer a particular instance of a fileserver, but rather to specify a policy that will apply to all instances of CLASS:FS. This is particularly true in a case where VMs may be provisioned and terminated automatically as a matter of load balancing. Specifying accustom policy for a single VM may be less effective if that VM is terminated a short time later. However, specifying a policy for CLASS:FS can be very effective, because each existing and new instance of CLASS:FS will get that policy.

Hierarchical specification of policy can be multi-tiered. For example, security administrator 150 may specify a top-level baselines policy for all new VMs. Security administrator 150 may then specify additions or exceptions to that policy for each class of VM. Finally, as necessary, security administrator 150 may specify individual additions or exceptions for individual VMs.

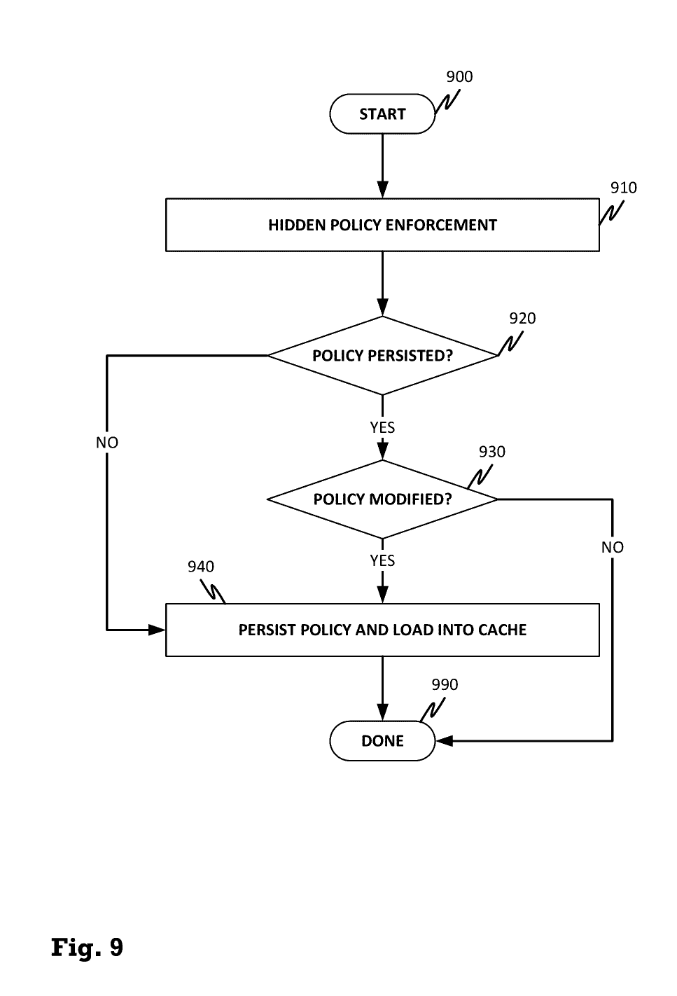

FIG. 9 is a flowchart of a method 900 performed by SVA 300 according to one or more examples of the present specification. In block 910.

In block 910, SVA 300 initiates hidden policy enforcement. In this block, SVA 300 saves the hidden policy as a file, such as an XML file. SVA 300 may also load the file into a map, cross-referencing the UUID of each VM to an identifier for one or more scan policies. For example, the hidden policy may have two main sections. First is a section, file, or table listing all scan policies. The second section is a mapping between VM UUIDs and scan policies, or in other words, which scan policy is assigned to which VM in management console 140.

In decision block 920, SVA 300 determines whether the policy is persisted. This means that in block 930, SVA 300 checks that the latest hidden policy data is consistent with the latest table. If changes are observed, then in block 940 SVA 300 saves the latest policy to the file system and also reloads the map into cache.

In block 990, the method is done.

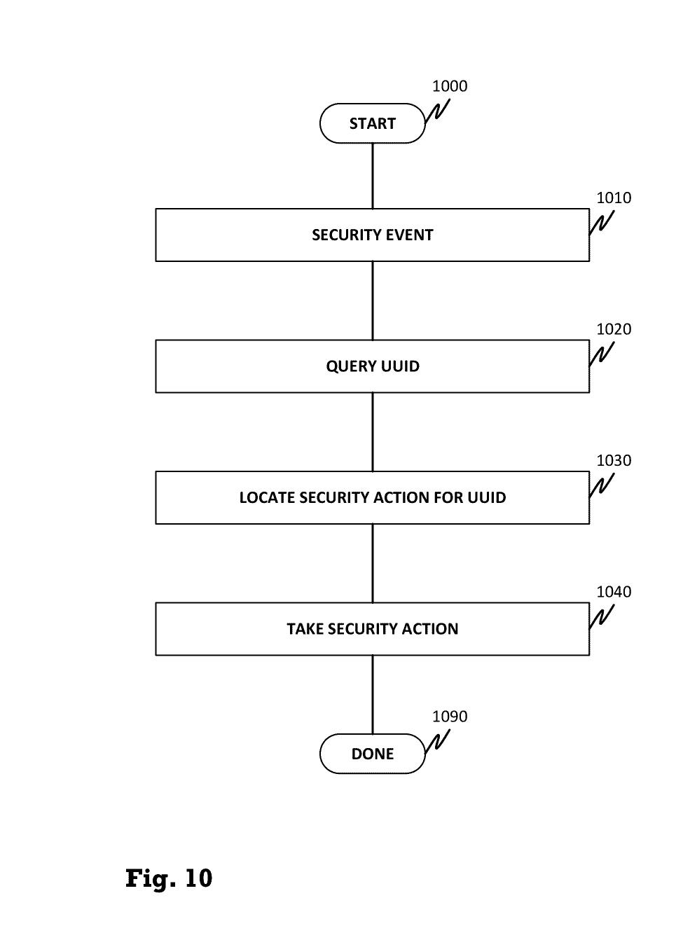

Turning to FIG. 10, a method 1000 is disclosed, also performed by SVA 300.

In block 1010, a security event occurs, such as a scan call.

In block 1020, SVA 300 queries the VM UUID and in block 1030, picks a scan policy corresponding to the UUID.

In block 1040, policy management engine 324 takes all actions specified by the scan policy.

The scan policy assigned to SVA 300 may be treated as a default policy setting for all VM's protected by SVA 300. In the lookup, if no scan policies are found for a given UUID, or a VM-based scan configuration is disabled in the SVA policy, then the SVA policy will be used as the default for that VM.

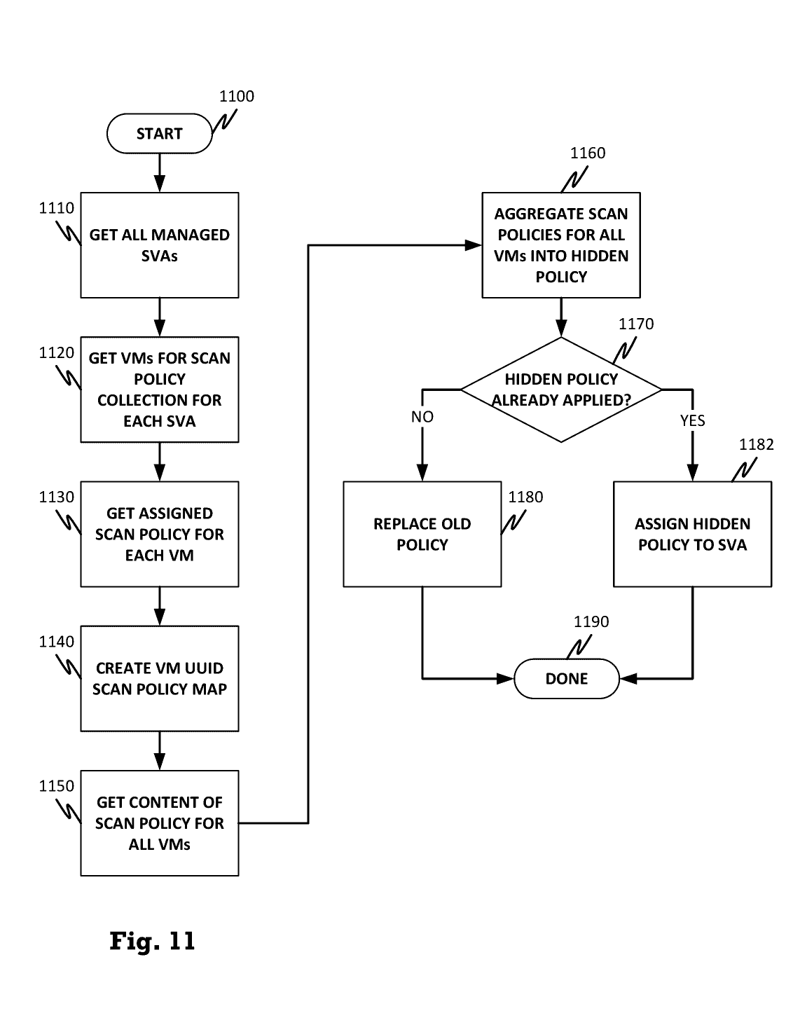

FIG. 11 is a flowchart of an example method performed by management console 140 according to one or more examples of the present specification.

In block 1100, management console gets a list of all managed SVA 300. This may be stored, for example, in a managed SVAs database, and may be accomplished by a stored procedure included in repository importer 630 of FIG. 6. Repository importer 630 returns a list of UUIDs for managed SVAs 300.

In block 1120, repository importer 630 gets a list of VMs for scan policy collection for each SVA 300. Each SVA 300 needs a list of virtual machines, including UUIDs, that it is managing. As part of this, repository importer 630 may first check which hypervisor 500 each SVA 300 is operating on. If the hypervisor 500 is not under the cluster, then management console 140 may select all virtual machines running on the hypervisor except the given SVA 300. Otherwise it may select all virtual machines running on each hypervisor under the cluster. Again, this may be accomplished via a stored procedure which returns a list of UUIDs for each managed VM.

In block 1130, management console 140 gets the assigned scan policy for each VM. The scan policy can be assigned to the VM on a rules basis or node basis. Policy assignments may be read directly. In some cases, for rule-based policy, no direct APIs are available. Thus, rule parser code may be used in a stored procedure to get the list of all rule-based policies. In this block, management console 140 collects the names of scan policies assigned each virtual machine for a given SVA 300.

In block 1140, management console 140 creates a mapping of VM UUIDs and scan policy names. After getting the scan policies for each VM 200 for each SVA 300, management console 140 creates a UUID-to-scan-policy name mapping for each SVA 300.

In block 1150, management console 140 gets the content of scan policies for all VMs. In this block, the management console reads the content and each policy discovered in block 1130, and maintains a list of policy content.

In block 1160, management console 140 aggregates scan policies for all VMs into a hidden policy. In this block, apart from SVA and scan policy type, a new policy type, named for example “VM settings,” is a hidden policy. This policy has been added into a default policy file. After collecting the data described in blocks 1130, 1140, and 1150, management console 140 creates a policy object of type VM settings for each SVA 300.

This hidden policy may have, for example, three sections.
1. Scan policies. List name of all the scan policies collected in block 1130.
2. Scan policies data. Content of all scan policies collected in block 1140.
3. Scan policies VM mapping. UUID and scan policy mapping collected in block 1150.

In decision block 1170, management console 140 determines whether the hidden policy has already been applied. If yes, then in block 1182, the created hidden policy for each SVA is assigned to its respective SVA 300. If no, in block 1182, the old policy is replaced. On each run, the last assigned hidden policy data may be overridden with newly-collected policy data for each SVA 300.

In certain examples, blocks 1110 through 1170 may run continuously as a server task. In one example, the default frequency of this task is 60 minutes. The task may also be run on demand if necessary, and the default frequency of the task may be overridden by a configuration.

Once the task is finished, then a wake-up agent call can be made to all managed SVAs 300, so that the assigned hidden policy for each SVA can be reached successfully on the SVA 300, or otherwise as part of the hidden policy.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

The particular embodiments of the present disclosure may readily include a system on chip (SOC) central processing unit (CPU) package. An SOC represents an integrated circuit (IC) that integrates components of a computer or other electronic system into a single chip. It may contain digital, analog, mixed-signal, and radio frequency functions: all of which may be provided on a single chip substrate. Other embodiments may include a multi-chip-module (MCM), with a plurality of chips located within a single electronic package and configured to interact closely with each other through the electronic package. In various other embodiments, the digital signal processing functionalities may be implemented in one or more silicon cores in Application Specific Integrated Circuits (ASICs), Field Programmable Gate Arrays (FPGAs), and other semiconductor chips.

Additionally, some of the components associated with described microprocessors may be removed, or otherwise consolidated. In a general sense, the arrangements depicted in the figures may be more logical in their representations, whereas a physical architecture may include various permutations, combinations, and/or hybrids of these elements. It is imperative to note that countless possible design configurations can be used to achieve the operational objectives outlined herein. Accordingly, the associated infrastructure has a myriad of substitute arrangements, design choices, device possibilities, hardware configurations, software implementations, equipment options, etc.

Any suitably-configured processor component can execute any type of instructions associated with the data to achieve the operations detailed herein. Any processor disclosed herein could transform an element or an article (for example, data) from one state or thing to another state or thing. In another example, some activities outlined herein may be implemented with fixed logic or programmable logic (for example, software and/or computer instructions executed by a processor) and the elements identified herein could be some type of a programmable processor, programmable digital logic (for example, a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof. In operation, processors may store information in any suitable type of non-transitory storage medium (for example, random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. Further, the information being tracked, sent, received, or stored in a processor could be provided in any database, register, table, cache, queue, control list, or storage structure, based on particular needs and implementations, all of which could be referenced in any suitable timeframe. Any of the memory items discussed herein should be construed as being encompassed within the broad term ‘memory.’

Computer program logic implementing all or part of the functionality described herein is embodied in various forms, including, but in no way limited to, a source code form, a computer executable form, and various intermediate forms (for example, forms generated by an assembler, compiler, linker, or locator). In an example, source code includes a series of computer program instructions implemented in various programming languages, such as an object code, an assembly language, or a high-level language such as OpenCL, Fortran, C, C++, JAVA, or HTML for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

In one example embodiment, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In another example embodiment, the electrical circuits of the FIGURES may be implemented as stand-alone modules (e.g., a device with associated components and circuitry configured to perform a specific application or function) or implemented as plug-in modules into application specific hardware of electronic devices.

Note that with the numerous examples provided herein, interaction may be described in terms of two, three, four, or more electrical components. However, this has been done for purposes of clarity and example only. It should be appreciated that the system can be consolidated in any suitable manner. Along similar design alternatives, any of the illustrated components, modules, and elements of the FIGURES may be combined in various possible configurations, all of which are clearly within the broad scope of this Specification. In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “steps for” are specifically used in the particular claims; and (b) does not intend, by any statement in the specification, to limit this disclosure in any way that is not otherwise reflected in the appended claims.

### Example Implementations

There is disclosed by way of example, a computing apparatus for providing policy per virtual machine (PPVM) on a plurality of virtual machines (VMs) on a hypervisor, comprising: a security virtual appliance (SVA) comprising a policy management engine operable for: receiving a policy rule set to define a security policy for a virtual machine (VM); building a policy table comprising a security policy entry for the VM; receiving an application programming interface (API) event notification from the VM; and issuing an API instruction to the VM to enforce the security policy entry.

There is further disclosed an example, wherein the policy table includes policy entries for a plurality of VMs.

There is further disclosed an example, wherein at least some of the VMs are identified by a universally unique identifier (UUID).

There is further disclosed an example, wherein issuing the API instruction to the VM to enforce the security policy entry comprises correlating the security policy entry to a UUID for the VM in the policy table.

There is further disclosed an example, wherein issuing the API instruction to the VM to enforce the security policy entry comprises issuing a file read instruction, and comparing a result of the file read instruction to a hash or fingerprint of a known malware object.

There is further disclosed an example, wherein issuing the API instruction to the VM to enforce the security policy entry comprises issuing an API instruction to quarantine or inoculate a file.

There is further disclosed an example, wherein issuing the API instruction to the VM to enforce the security policy entry comprises issuing an API instruction to perform a registry read.

There is further disclosed an example, wherein issuing the API instruction to the VM to enforce the security policy entry comprises issuing an API instruction to perform a registry write.

There is further disclosed an example, wherein the API event is a file event.

There is further disclosed an example, wherein the file event is selected from the group consisting of read, write, access, create, delete, or replace.

There is further disclosed an example, wherein the policy management engine is further operable for issuing an API scan instruction.

There is further disclosed an example, wherein the API scan instruction is operable for generating a file access event for some or all files of the VM.

There is further disclosed an example, wherein the policy management engine is further operable for detecting that the VM has been displaced to a second hypervisor, and replicating at least part of the policy table to the second hypervisor.

There is further described by way of example, one or more computer-readable mediums having stored thereon software instructions for provisioning a security virtual appliance (SVA) within a hypervisor, the SVA comprising a policy management engine operable for: receiving a policy rule set to define a security policy for a virtual machine (VM); building a policy table comprising a security policy entry for the VM; receiving an application programming interface (API) event notification from the VM; and issuing an API instruction to the VM to enforce the security policy entry.

There is further disclosed an example, wherein the policy table includes policy entries for a plurality of VMs.

There is further disclosed an example, wherein at least some of the VMs are identified by a universally unique identifier (UUID).

There is further disclosed an example, wherein issuing the API instruction to the VM to enforce the security policy entry comprises correlating the security policy entry to a UUID for the VM in the policy table.

There is further disclosed an example, wherein issuing the API instruction to the VM to enforce the security policy entry comprises issuing a file read instruction, and comparing a result of the file read instruction to a hash or fingerprint of a known malware object.

There is further disclosed an example, wherein issuing the API instruction to the VM to enforce the security policy entry comprises issuing an API instruction to quarantine or inoculate a file.

There is further disclosed an example, wherein issuing the API instruction to the VM to enforce the security policy entry comprises issuing an API instruction to perform a registry read or write.

There is further disclosed an example, wherein the API event is a file event.

There is further disclosed an example, wherein the policy management engine is further operable for issuing an API scan instruction operable for generating a file access event for some or all files of the VM.

There is further disclosed an example, wherein the policy management engine is further operable for detecting that the VM has been displaced to a second hypervisor, and replicating at least part of the policy table to the second hypervisor.

There is further disclosed by way of example, a management console apparatus, comprising: a security management engine operable for interfacing with one or more security virtual appliances (SVAs), the one or more SVAs configured to provide a user-configurable policy per virtual machine (PPVM) security framework to a plurality of agentless virtual machines via virtual machine (VM) application programming interface (API) instructions; and a user interface driver operable for receiving a user input to configure the configurable PPVM.

There is further disclosed an example, wherein the security management engine is further operable for providing a persistent PPVM to a virtual machine upon the virtual machine moving from a first hypervisor to a second hypervisor.

There is further disclosed in an example, a method comprising performing the instructions disclosed in any of the examples.

There is further disclosed in an example, an apparatus comprising means for performing the method of any of the examples.

There is further disclosed an example, wherein the apparatus comprises a processor and memory.

There is further disclosed in an example, an apparatus further comprising a computer-readable medium having stored thereon software instructions for performing the method of any of the examples.

What is claimed is:

1. A computing apparatus for providing policy per virtual machine (PPVM) on a plurality of virtual machines (VMs) on a hypervisor, comprising:
a security virtual appliance (SVA) comprising a policy management engine operable for:
receiving a policy rule set to define a security policy for a virtual machine (VM);
building a policy table comprising a security policy entry for the VM;
receiving an application programming interface (API) event notification from the VM; and
issuing an API instruction to the VM to enforce the security policy entry.

2. The computing apparatus of claim 1, wherein the policy table includes policy entries for a plurality of VMs.

3. The computing apparatus of claim 2, wherein at least some of the VMs are identified by a universally unique identifier (UUID).

4. The computing apparatus of claim 3, wherein issuing the API instruction to the VM to enforce the security policy entry comprises correlating the security policy entry to a UUID for the VM in the policy table.

5. The computing apparatus of claim 1, wherein issuing the API instruction to the VM to enforce the security policy entry comprises issuing a file read instruction, and comparing a result of the file read instruction to a hash or fingerprint of a known malware object.

6. The computing apparatus of claim 1, wherein issuing the API instruction to the VM to enforce the security policy entry comprises issuing an API instruction to quarantine or inoculate a file.

7. The computing apparatus of claim 1, wherein issuing the API instruction to the VM to enforce the security policy entry comprises issuing an API instruction to perform a registry read.

8. The computing apparatus of claim 1, wherein issuing the API instruction to the VM to enforce the security policy entry comprises issuing an API instruction to perform a registry write.

9. The computing apparatus of claim 1, wherein the API event is a file event.

10. The computing apparatus of claim 9, wherein the file event is selected from the group consisting of read, write, access, create, delete, or replace.

11. The computing apparatus of claim 1, wherein the policy management engine is further operable for issuing an API scan instruction.

12. The computing apparatus of claim 11, wherein the API scan instruction is operable for generating a file access event for some or all files of the VM.

13. The computing apparatus of claim 1, wherein the policy management engine is further operable for detecting that the VM has been displaced to a second hypervisor, and replicating at least part of the policy table to the second hypervisor.

14. One or more computer-readable mediums having stored thereon software instructions for provisioning a security virtual appliance (SVA) within a hypervisor, the SVA comprising a policy management engine operable for:
receiving a policy rule set to define a security policy for a virtual machine (VM);
building a policy table comprising a security policy entry for the VM;
receiving an application programming interface (API) event notification from the VM; and
issuing an API instruction to the VM to enforce the security policy entry.

15. The one or more computer-readable mediums of claim 14, wherein the policy table includes policy entries for a plurality of VMs.

16. The one or more computer-readable mediums of claim 15, wherein at least some of the VMs are identified by a universally unique identifier (UUID).

17. The one or more computer-readable mediums of claim 16, wherein issuing the API instruction to the VM to enforce the security policy entry comprises correlating the security policy entry to a UUID for the VM in the policy table.

18. The one or more computer-readable mediums of claim 14, wherein issuing the API instruction to the VM to enforce the security policy entry comprises issuing a file read instruction, and comparing a result of the file read instruction to a hash or fingerprint of a known malware object.

19. The one or more computer-readable mediums of claim 14, wherein issuing the API instruction to the VM to enforce the security policy entry comprises issuing an API instruction to quarantine or inoculate a file.

20. The one or more computer-readable mediums of claim 14, wherein issuing the API instruction to the VM to enforce the security policy entry comprises issuing an API instruction to perform a registry read or write.

21. The one or more computer-readable mediums of claim 14, wherein the API event is a file event.

22. The one or more computer-readable mediums of claim 14, wherein the policy management engine is further operable for issuing an API scan instruction operable for generating a file access event for some or all files of the VM.

23. The one or more computer-readable mediums of claim 14, wherein the policy management engine is further operable for detecting that the VM has been displaced to a second hypervisor, and replicating at least part of the policy table to the second hypervisor.

24. A management console apparatus, comprising:
a security management engine operable for interfacing with one or more security virtual appliances (SVAs), the one or more SVAs configured to provide a user-configurable policy per virtual machine (PPVM) security framework to a plurality of agentless virtual machines via virtual machine (VM) application programming interface (API) instructions; and
a user interface driver operable for receiving a user input to configure the configurable PPVM.

25. The management console apparatus of claim 24, wherein the security management engine is further operable for providing a persistent PPVM to a virtual machine upon the virtual machine moving from a first hypervisor to a second hypervisor.
